(19) United States
(12) Patent Application Publication
(10) Pub. No.: US 2018/0039954 A1
(43) Pub. Date: Feb. 8, 2018

(54) MEETING TIME PICKER WITH AUTOMATED SUGGESTIONS

(71) Applicant: MICROSOFT TECHNOLOGY LICENSING, LLC, Redmond, WA (US)

(72) Inventors: Mark Daniel MacKenzie, Seattle, WA (US); Hiroshi Tsukahara, Bellevue, WA (US); Philipp Cannons, Redmond, WA (US)

(73) Assignee: MICROSOFT TECHNOLOGY LICENSING, LLC, Redmond, WA (US)

(21) Appl. No.: 15/366,657

(22) Filed: Dec. 1, 2016

Related U.S. Application Data
(60) Provisional application No. 62/371,853, filed on Aug. 8, 2016.

(51) Int. Cl. G06Q 10/10; H04W 4/02

(52) U.S. Cl. CPC G06Q 10/1095; H04W 4/028

(57) ABSTRACT

Variety of approaches to provide a meeting time picker with automated suggestions are described. A calendar application initiates operations to provide a meeting time picker upon detecting an intent of a meeting organizer to organize a meeting. The intent lists a meeting invitee. Availability information associated with the meeting invitee is retrieved from a calendar provider. A first layer, a second layer, and third layer of timeslots are generated for a presentation. The first layer includes a meeting organizer schedule. The second layer includes an aggregate schedule of the meeting invitee. The third layer includes a suggested schedule of a meeting time. The first layer, the second layer, and the third layer are presented in a scheduling grid to the meeting organizer.

### CROSS-REFERENCE TO RELATED APPLICATIONS

This application claims the benefit under 35 U.S.C. § 119(e) of U.S. Provisional Patent Application Ser. No. 62/371,853 filed on Aug. 8, 2016. The disclosure of the U.S. Provisional Patent Application is hereby incorporated by reference in its entirety.

### BACKGROUND

Information collection, management, and analysis have changed work processes and associated time management. Automation and improvements in work processes have expanded scope of capabilities offered by businesses. With the development of faster and smaller electronics, execution of mass processes at data analysis systems have become feasible. Indeed, analysis work at data centers, data-warehouses, data workstations have become common experience in modern work and personal environments. Such systems provide a wide variety of applications such as calendar applications managing time resources. Many such applications provide time resource management to manage tasks, events, and meetings. Meeting management consume significant resources and performance at a promise of improved time based resource management and condensed task flows.

Improved meeting management techniques are becoming ever more important as time based resource management complexity increases across the computer industry. Variety of techniques are necessary to setup a meeting and to hold the meeting. There are currently significant gaps when providing meeting organization coordination and when providing tools to setup a meeting. Lack of relevant meeting organization methods in relation to a meeting invitees lead to poor management of the meeting.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a meeting time picker with automated suggestions. A calendar application, according to embodiments, may initiate operations to provide a time picker upon detecting an intent of an organizer to organize a meeting. The intent may list a meeting invitee. Next, availability information associated with the meeting invitee may be retrieved. Furthermore, the calendar application may generate a first layer that includes a meeting organizer schedule, a second layer that includes an aggregate schedule of the meeting invitee, and a third layer that includes a suggested schedule of a meeting time. The first layer, the second layer, and the third layer may be presented in a scheduling grid to the meeting organizer.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing a meeting time picker with automated suggestions, according to embodiments;

FIG. 2 is a display diagram illustrating example components of a user interface of a calendar application that provides a meeting time picker with automated suggestions, according to embodiments;

FIG. 3 is a display diagram illustrating an example of automated meeting time selection by a meeting time picker, according to embodiments;

FIG. 4 is a display diagram illustrating an example of providing automated meeting time suggestions based on contextual information, according to embodiments;

FIG. 5 is a simplified networked environment, where a system according to embodiments may be implemented;

FIG. 6 is a block diagram of an example computing device, which may be used to provide a meeting time picker with automated suggestions, according to embodiments; and

FIG. 7 is a logic flow diagram illustrating a process for providing a meeting time picker with automated suggestions, according to embodiments.

### DETAILED DESCRIPTION

As briefly described above, a calendar application may provide a meeting time picker with automated suggestions. In an example scenario, the calendar application may detect an intent of a meeting organizer to organize a meeting. The intent may list a meeting invitee. The meeting organizer may interact with a user interface (UI) of the calendar application to organize the meeting. Next, availability information associated with the meeting invitee may be retrieved. The availability information may include a schedule of the meeting invitee retrieved from a calendar provider associated with the meeting invitee.

The calendar application may generate a first layer that includes a meeting organizer schedule, a second layer that includes an aggregate schedule of the meeting invitee, and a third layer that includes a suggested schedule of a meeting time. The first, second, and/or the third layers may include timeslots with state information associated with the meeting organizer, the meeting invitee, and/or the meeting. The first, second, and/or the third layers may be presented to a scheduling grid to the meeting organizer. The scheduling grid may encompass timeslots including the state information associated with the meeting organizer, the meeting invitee, and/or the meeting.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in tire general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a meeting time picker with automated suggestions. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

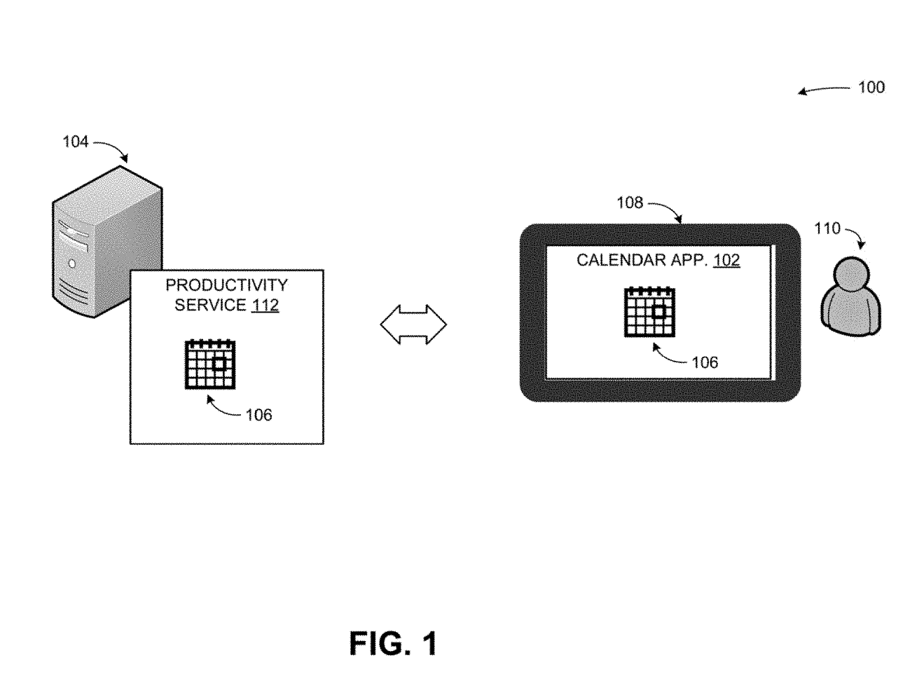

FIG. 1 is a conceptual diagram illustrating examples of providing a meeting time picker with automated suggestions, according to embodiments.

In a diagram 100, a computing device 108 may execute a calendar application 102. The computing device 108 may include a physical computer and/or a mobile computing device such as a smart phone and/or similar ones. The computing device 108 may also include a special purpose and/or configured device that is optimized to execute data operations associated with the calendar application 192. For example, the computing device 108 may include physical components that are custom built to accelerate operations associated with a meeting with multiple computation corns tailored to process number of data steams associated with the meeting.

The computing device 108 may execute the calendar application 102. The calendar application 102 may initiate operations to provide a meeting time picker upon detecting an intent of a meeting organizer 110 to organize a meeting 106. An example of the intent may include interaction(s) with a UI of the calendar application to organize the meeting 106. Next, availability information associated with the meeting invitee may be retrieved. The availability information may include a schedule of the meeting invitee retrieved from a calendar provider associated with the meeting invitee. The schedule may include an available timeslot and/or a busy timeslot, among others.

The calendar application may generate a number of layers for display to convey information related to meeting time(s). For example, the calendar application may generate a first layer that includes a meeting organizer schedule. In addition, the calendar application may generate a second layer that includes an aggregate schedule of the meeting invitee. Furthermore, the calendar application may generate a third layer that includes a suggested schedule of a meeting time. The first, second, and/or the third layers may include timeslots with state information associated with the meeting organizer 110, the meeting invitee, and/or the meeting 106.

The first, second, and/or the third layers may be presented in a scheduling grid to the meeting organizer 110. The scheduling grid may encompass timeslots including the state information associated with the meeting organizer 110, the meeting invitee, and/or the meeting. The state information may describe a busy state, and/or an available state, among others.

The computing device 108 may communicate with other client device(s) or server(s) through a network. The network may provide wired or wireless communications between network nodes such as the computing device 108, other client device(s) and/or server(s) such as the data store 104, among others. Previous example(s) to provide a meeting time picker with automated suggestions by the calendar application 102 are not provided in a limiting sense. Alternatively, a productivity service 112 may provide meeting time analysis and automated suggestions. Furthermore, the productivity service 112 may provide the calendar application 102 as a client interface for execution by the computing device 108.

The meeting organizer 110 may interact with the calendar application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the calendar application 102, embodiments are not limited to these components or system configurations and can be implemented with other system configuration employing fewer or additional components.

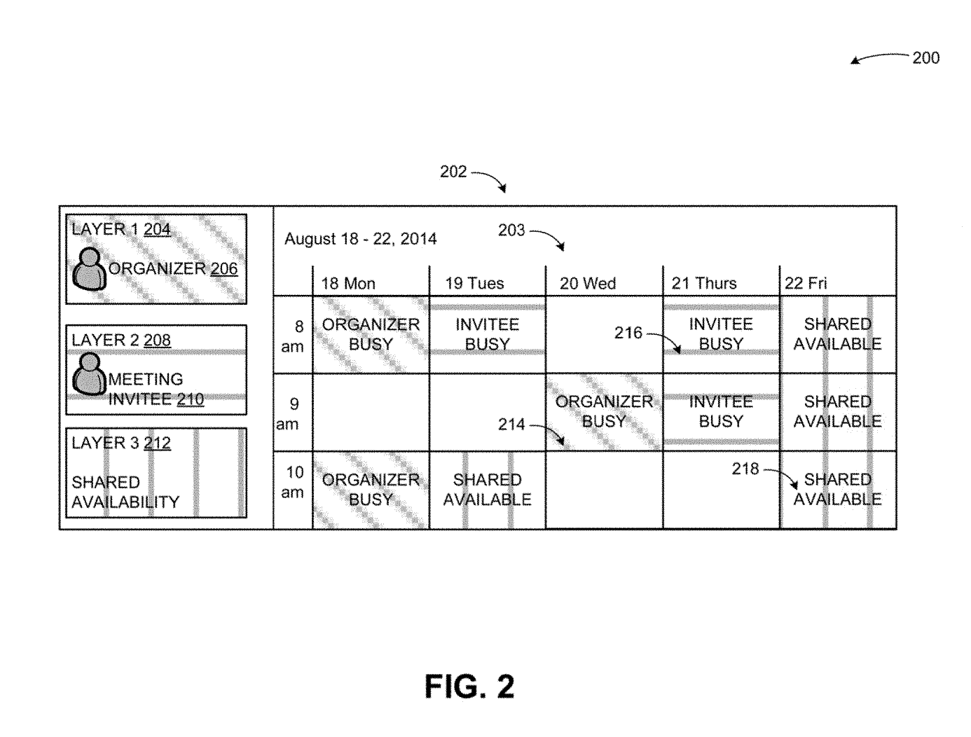

FIG. 2 is a display diagram illustrating example components of a user interface of a calendar application that provides a meeting time picker with automated suggestions, according to embodiments.

In a diagram 200, a scheduling module of a calendar application 202 may present a scheduling grid 203. A meeting organizer 206 may select a calendar window to display in the scheduling grid 203. The calendar window may include a date range, and/or a time range, among others. The meeting timeslot may also be selected by a meeting organizer 206 from presented suggestions in the calendar window. Alternatively, the scheduling module of the calendar application may automatically select an available timeslot as a timeslot for the meeting and/or schedule the meeting at the available timeslot.

The scheduling grid 203 may include layers of timeslots that present scheduling information associated with the meeting organizer 206, a meeting invitee 210, and suggested meeting time(s). For example, the scheduling module may generate and present a layer 1 (204) that includes a meeting organizer schedule. The meeting organizer schedule may include an available timeslot and/or a busy timeslot 214. In an example scenario, the busy timeslot 214 may display contextual information such as a location of the meeting organizer 206 during the busy timeslot 214.

The schedule may also generate and present a layer 2 (208) of an aggregate schedule of the meeting invitee 210. A schedule of the meeting invitee 210 may be aggregated with schedule(s) of the other meeting invitee(s) to generate the aggregate schedule presented in the layer 2 (208). For example, a shared busy timeslot of the meeting invitee 210 and other meeting invitee(s) may be aggregated to generate an invitee busy timeslot 216. The invitee busy timeslot 216 may include and present status information associated with the invitee (and other invitee(s)) such as busy and/or available (among others) and presence information associated with the invitee (and other invitee(s)) such as a location of the invitee (and other invitee(s)).

Upon an analysis of the timeslot(s) in the layer 1 (204) and the layer 2 (208), the scheduling module of the calendar application 202 may generate a layer 3 (212). The layer 3 (212) may include times lots with shared availability between the meeting organizer 206 and the meeting invitee 210 (along with any other meeting invitee(s)). Upon identifying a shared available timeslot 218, the shared available timeslot 218 may be inserted into the layer 3 (212) as a suggested meeting timeslot.

Availability information associated with the meeting organizer 206 and the meeting invitee 210 may be used to generate the layer 3 (212). The availability information may be retrieved from a calendar associated with the meeting organizer 206 and/or a calendar associated with the meeting invitee. The calendar(s) for the meeting organizer 206 and/or the meeting invitee may be accessed through calendar provider(s). The calendar provider(s) for the meeting organizer 206 and the meeting invitee may or may not be the same entity.

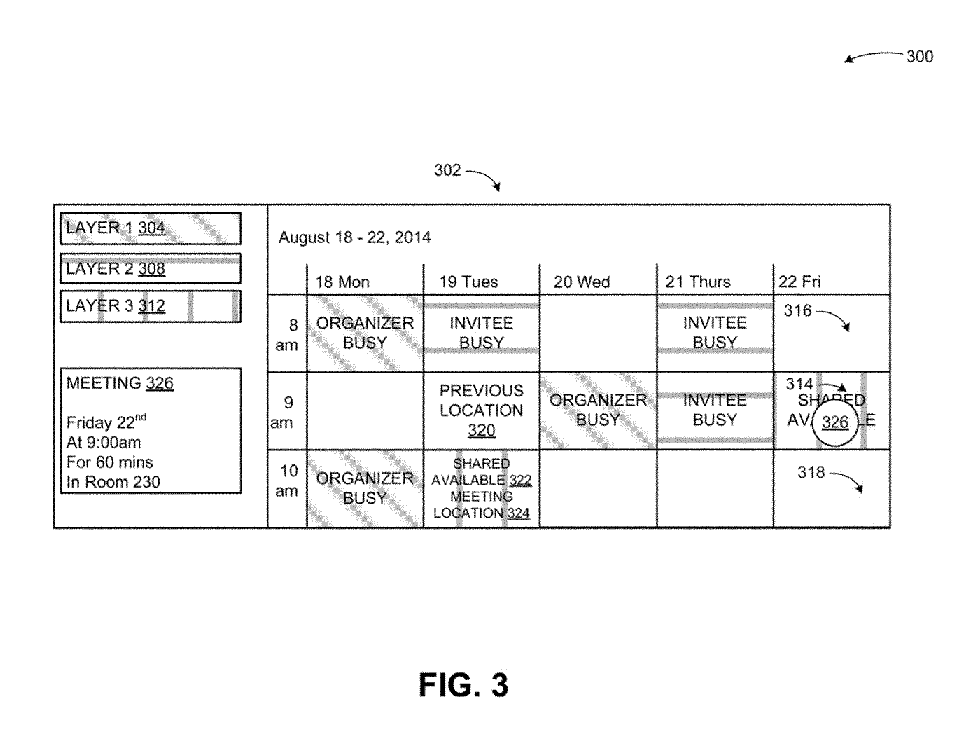

FIG. 3 is a display diagram illustrating an example of automated meeting time selection by a meeting time picker, according to embodiments.

In a diagram 300, a scheduling module of a calendar application 302 may generate a layer 1 (304) that includes a meeting organizer schedule, a layer 2 (308) that includes an aggregate schedule of the meeting invitee (and other meeting invitee(s)), and a layer 3 (312) that includes a suggested schedule of a meeting time. The scheduling module of a calendar application 302 may identify a suggested timeslot for a meeting upon analysis and discovery of shared available timeslot(s) between the schedules for the meeting organizer and the meeting invitee(s).

For example, shared available timeslots (314 and 322) may be suggested as meeting timeslots because the timeslots are indicated as available for both the meeting organizer and the meeting invitee. In an example scenario, the meeting organizer may select the shared available timeslot 314 as the meeting 326. In response to the selection, the scheduling module of the calendar application 302 may display contextual information associated with the meeting such as a date, a start time, a duration, and a location of the meeting 326.

The scheduling module of the calendar application 302 may also use contextual information to select the shared available timeslots (314 and 324). The contextual information may be associated with the meeting organizer, and/or the meeting invitee, among others. For example, a previous location 320 of the meeting invitee may be retrieved from a previous timeslot (of the meeting invitee) adjacent to the shared available timeslot 322. A distance between the previous location and a meeting location (selected by the meeting organizer) may be computed. Next, a travel time (of the meeting invitee) to the meeting location may be computed based on the distance and a travel mode associated with the meeting invitee. The travel mode may be detected by analyzing a contextual information associated with the meeting invitee. The contextual information may be retrieved from a contact information provider, a presence information provider, a personnel information provider, and/or a social networking provider, among others.

For example, a previous location of a room in a first building and a meeting location of another room in a second building may be used to compute a distance that the meeting invitee may travel to arrive at the meeting. Next, a travel mode of the meeting invitee (such as walking, and/or driving, among others) may be considered to compute the travel time to the meeting. Traffic congestion on the way to the meeting 326 may also considered as a detriment or benefit while computing the travel time.

If the travel time is identified as within an acceptable threshold from a start time of the meeting 326, the shared available timeslot 322 may be maintained in the layer 3 (312) as a suggested meeting timeslot. For example, if the meeting invitee's travel time is computed as 4 minutes from a location during a previous timeslot to the meeting location and the travel time is identified as under a delay threshold of 5 minutes then the shared available timeslot 322 may be maintained as a suggested meeting timeslot in the layer 3 (312).

However, if the travel time is identified as outside an acceptable threshold from a start time of the meeting, the shared available timeslot 322 may be removed from the layer 3 (312) as a suggested meeting timeslot. For example, if the meeting invitee's travel time is computed as 10 minutes from a location during a previous timeslot to the meeting location and the travel time is identified as over a delay threshold of 5 minutes then the shared available timeslot 322 may be removed from the layer 3 (312). The delay threshold may be configured by the meeting organizer and/or as a dynamic and or static system based attribute.

In another example scenario, the scheduling module of the calendar application 302 may further refine suggested timeslot selection for the meeting 326 by analyzing timeslots adjoining a shared available timeslot. For example, if a shared previous timeslot 316 before the shared available timeslot 314 is identified as available then the shared available timeslot 314 may be maintained in the layer 3 (312) as a suggested timeslot for the meeting 326. Alternatively, if the shared previous times lot 316 before the shared available timeslot 314 is identified as unavailable then the shared available timeslot 314 may be removed from the layer 3 (312).

Similarly, if a shared subsequent timeslot 318 after the shared available timeslot 314 may be identified as available, the shared mailable timeslot 314 may be maintained within the layer 3 (312) as a suggested timeslot for the meeting 326. Alternately, if the shared subsequent timeslot 318 after the shared available timeslot 314 is identified as unavailable then the shared available timeslot 314 may be removed from the layer 3 (312).

The scheduling module of the calendar application 302 may consider the shared previous timeslot 316 and the shared subsequent timeslot 318 when scheduling the meeting 326. The timeslot(s) are considered because if any of the shared previous timeslot 316 and the shared subsequent timeslot 318 may be identified as unavailable, a chance of the meeting invitee and/or the meeting organizer to attend the meeting and/or arrive at the meeting may diminish because of prior or post engagements with other activities.

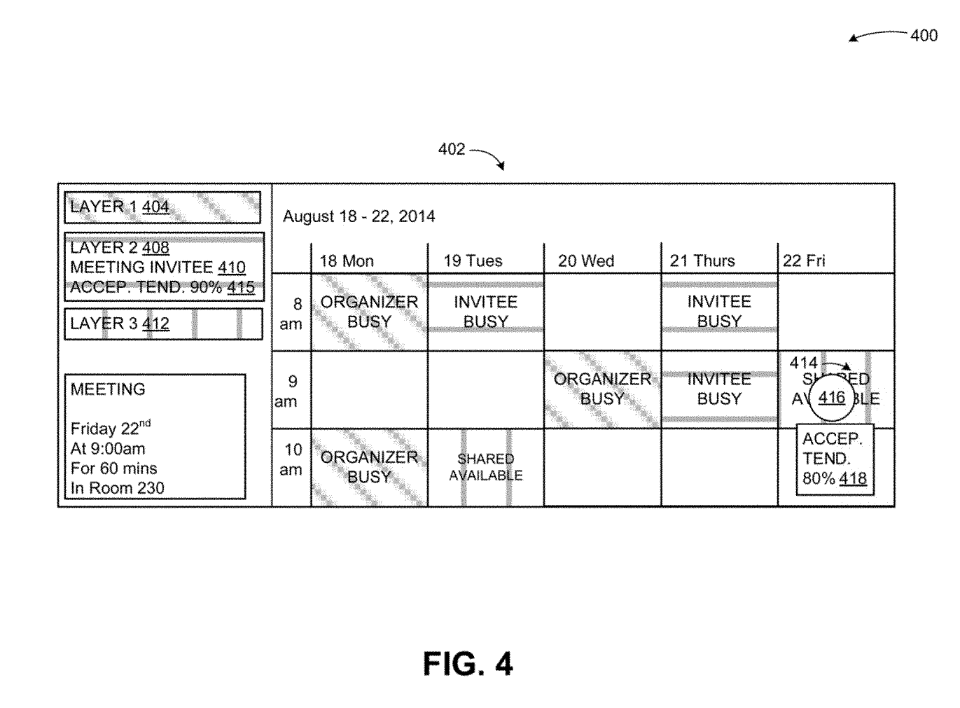

FIG. 4 is a display diagram illustrating an example of providing automated meeting time suggestions based on contextual information, according to embodiments.

In a diagram 400, a scheduling module of the calendar application 402 may analyze historical meeting data associated with a meeting invitee. An acceptance tendency (415 or 418) may be identified. The acceptance tendency 415 may describe a percentage, of meeting invites (from a meeting organizer) accepted by the meeting invitee 410. The acceptance tendency 418 may describe a percentage of meeting invites (at a shared available timeslot 414) accepted by the meeting invitee 410.

For example, if the acceptance tendency 415 and/or the acceptance tendency 418 may be identified to fall below an acceptance tendency threshold (such as 50%), the shared available timeslot 414 may be removed from a layer 3 (412). Alternatively, if the acceptance tendency 415 and/or the acceptance tendency 418 may be identified to rise above an acceptance tendency threshold (such as 70%), the shared available timeslot 414 may be maintained in the layer 3 (412) as a suggested meeting timeslot. In such a scenario, the scheduling module of the calendar application 402 may automatically schedule the meeting 416 at the shared available timeslot 414.

The scheduling module of the calendar application 402 may also distinguish the layer 1 (404), the layer 2 (408), and the layer 3 (412) with a coloring scheme, a highlighting scheme and/or a shading scheme, among others, from each other. Furthermore, the meeting organizer may be notified of the shared available times lot 414 with an animation scheme for distinguishing the layer 3 (412) from the layer 1 (404) and/or the layer 2 (408).

As discussed above, the calendar application may be employed to provide a meeting time picker with automated suggestions. An increased user efficiency with the calendar application 102 may occur as a result of automatically presenting suggestions for a meeting timeslot. Timeslot analysis for availability of the meeting organizer and the meeting invitee may automate detection of suggested meeting timeslots. As such, automated meeting timeslot suggestions may reduce processor load, increase processing speed, conserve memory, and reduce network bandwidth usage.

Embodiments, as described herein, address a need that arises from a lack of efficiency to provide a meeting time picker with automated suggestions. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a meeting time picker with automated suggestions may be implemented in configurations employing fewer or additional components in applications and user interfaces. Furthermore, the example schema and components shown in FIG. 1 through 4 and their subcomponents may be implemented in a similar manner with other values using the principles described herein.

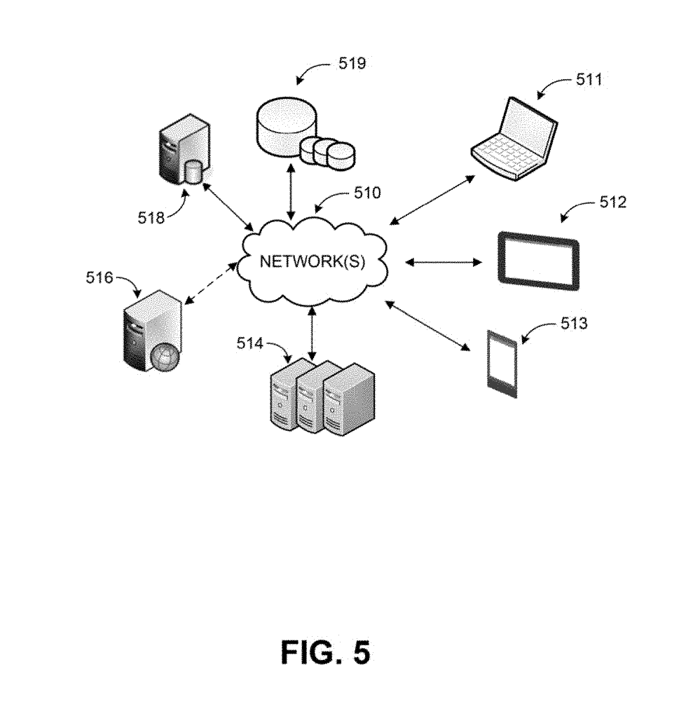

FIG. 5 is an example networked environment, where embodiments may be implemented. A calendar application configured to provide a meeting time picker with automated suggestions may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A calendar application may detect an intent of a meeting organizer to organize a meeting. The intent may list a meeting invitee. Availability information associated with the meeting invitee may be retrieved. A first layer that includes a meeting organizer schedule, a second layer that includes an aggregate schedule of the meeting invitee, and a third layer that includes a suggested schedule of a meeting time may be generated. Next, the first layer, the second layer, and the third layer may be presented in a scheduling grid to the meeting organizer. The calendar application may store data associated with the meeting invite in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a meeting time picker with automated suggestions. Furthermore, the networked environments discussed in FIG. 5 are for illustration purposes only. Embodiments are not limited to the example applications, modules, or processes.

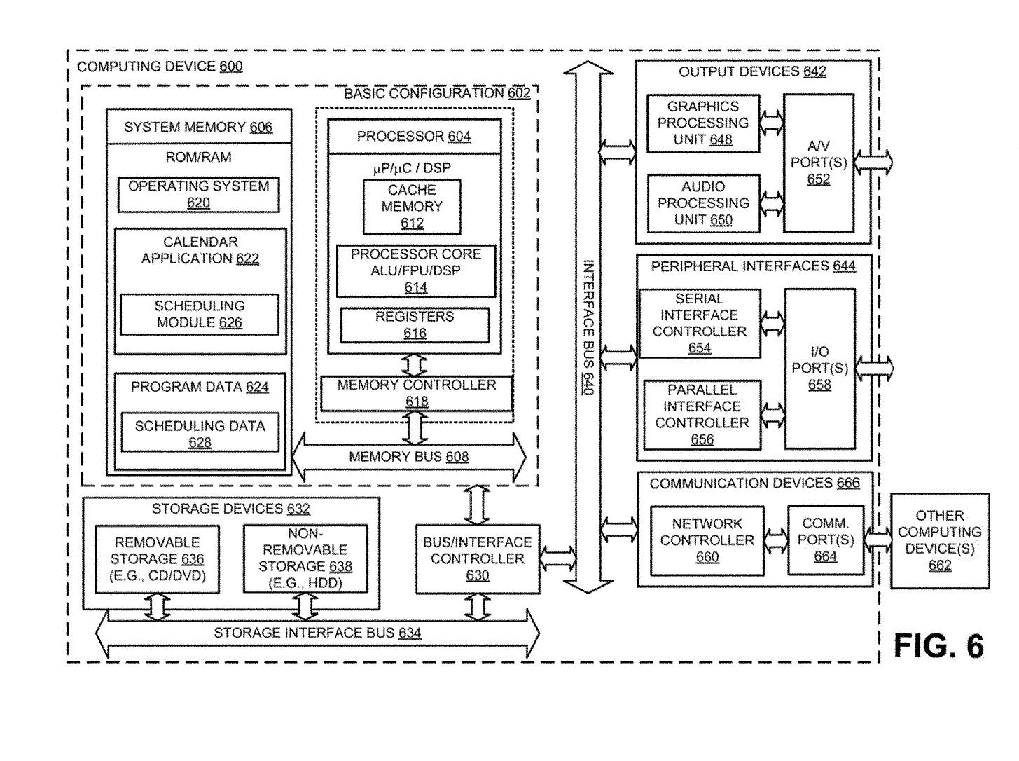

FIG. 6 is a block diagram of an example computing device, which may be used to provide a meeting time picker with automated suggestions, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP) a microcontroller (μC), a digital signal processor (DSP), or any combination thereof. The processor 604 may include one more levels of caching, such as a level cache memory 612, one or more processor cores 614 and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limbed to volatile memory (such as RAM), non-volatile memory such as ROM, flash memory, etc.), or any combination thereof. The system memory 606 may include an operating system 620, a calendar application 622, and a program data 624. The calendar application 622 may include components such as a scheduling module 626. The scheduling module 626 may execute the processes associated with the calendar application 622. The scheduling module 626 may detect an intent of a meeting organizer to organize a meeting. The intent may list a meeting invitee. Availability information associated with the meeting invitee may be retrieved. A first layer that includes a meeting organizer schedule, a second layer that includes an aggregate schedule of the meeting invitee, and a third layer that includes a suggested schedule of a meeting time may be generated. Next, the first layer, the second layer, and the third layer may be presented in a scheduling grid to the meeting organizer.

The calendar application 622 may display the suggested meeting timeslot(s) through a display component associated with the computing device 600. An example of the display component may include a monitor, and/or a touch screen, among others that may be communicatively coupled to the computing device 600. The program data 624 may also include, among other data, scheduling data 628, or the like, as described herein. The scheduling data 628 may include the availability information and suggested meeting timeslot(s).

The computing device 600 may have additional features or functionality, and additional interlaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interlace bus 640 for facilitating communication from various interface devices (for example, one or more output devices 642, one or move peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660 which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a pair of a general purpose or specialized serves, mainframe, or similar computer, winch includes any of the above functions. The computing device 600 may also be implemented as a personal computer including both laptop computer and non-laptop computer configurations.

Example embodiments may also include methods to provide a meeting time picker with automated suggestions. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

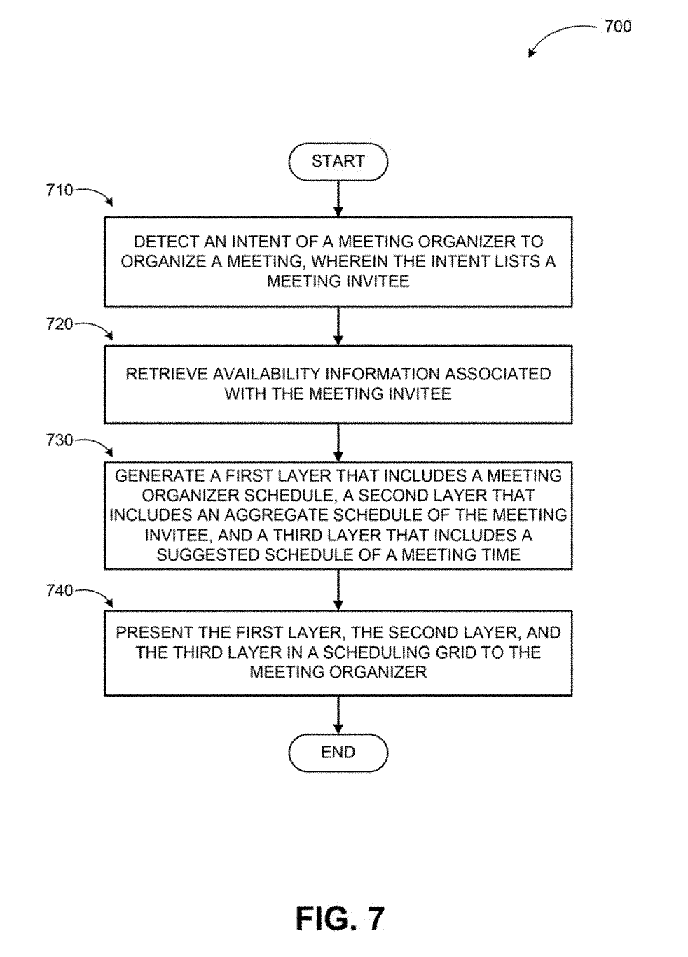

FIG. 7 is a logic flow diagram illustrating a process for providing a meeting time picker with automated suggestions, according to embodiments. Process 700 may be implemented on a computing device, such as the computing device 600 or another system.

Process 700 begins with operation 710, where the calendar application detects an intent of a meeting organizer to organize a meeting. The intent may list a meeting invitee. At operation 720, availability information associated with the meeting invitee may be retrieved from a calendar provider associated with the meeting invitee. The calendar provider may or may not be the same entity that provides availability information associated with the meeting organizer.

At operation 730, a first layer that includes a meeting organizer schedule, a second layer that includes an aggregate schedule of the meeting invitee, and a third layer that includes a suggested schedule of a meeting time may be generated. At operation 740, the first layer, the second layer, and the third layer may be presented to the meeting organizer in a scheduling grid.

The operations included in process 700 are for illustration purposes. Providing a meeting time picker with automated suggestions may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to provide a meeting time picker with automated suggestions is described. The computing device includes a display component, a memory configured to store instructions associated with a calendar application, and a processor coupled to the memory and the display component. The processor executes the calendar application in conjunction with the instructions stored in the memory. The calendar application includes a scheduling module. The scheduling module is configured to detect an intent of a meeting organizer to organize a meeting, wherein the intent lists a meeting invitee, retrieve availability information associated with the meeting invitee, generate a first layer that includes a meeting organizer schedule, a second layer that includes an aggregate schedule of the meeting invitee, and a third layer that includes a suggested schedule of a meeting time, and present, through the display component, the first layer, the second layer, and the third layer in a scheduling grid to the meeting organizer.

In other examples, the scheduling module is further configured to identify one or more of: a busy timeslot and an available timeslot in the meeting organizer schedule and insert the one or more of: the busy timeslot and the available timeslot into the first layer. The scheduling module is further configured to identify another meeting invitee within the intent and retrieve other availability information associated with the other meeting invitee. The scheduling module is further configured to identify a shared as available timeslot within the availability information associated with the meeting invitee and the other availability information associated with the other meeting invitee and insert the shared available timeslot into the second layer. The scheduling module is further configured to identify a busy timeslot within one or more of the availability information associated with the meeting invitee and the other availability information associated with the other invitee and insert the busy timeslot into the second layer.

In further examples, the scheduling modules is further configured to identify a shared available timeslot within the meeting organizer schedule and the availability information associated with the meeting invitee and insert the shared available timeslot into the third layer. The scheduling module is further configured to retrieve a previous location of the meeting invitee from a previous timeslot prior to the shared available timeslot, compute a distance between the previous location and a meeting location, and compute a travel time of the meeting invitee to the meeting location based on the distance and a travel mode associated with the meeting invitee. The scheduling module is further configured to identify the travel time as within an acceptable delay threshold from a start time of the meeting and maintain the shared available timeslot within the third layer. The scheduling module is further configured to identify the travel time as outside an acceptable delay threshold from a start time of the meeting and remove the shared available timeslot from the third layer. The scheduling module is further configured to detect the travel mode by analyzing a contextual information associated with the meeting invitee, wherein the contextual information is retrieved from one or more of: a contact information provider, a presence information provider, a personnel information provider, and a social networking provider associated with the meeting invitee.

In other examples, the scheduling module is further configured to in response to identifying a shared previous timeslot before the shared available timeslot as available within the meeting organizer schedule and the availability information associated with the meeting invitee, maintain the shared available timeslot within the third layer and in response to identifying a shared previous timeslot before the shared available timeslot as unavailable within one or more of the meeting organizer schedule and the availability information associated with the meeting invitee, remove the shared available timeslot from the third layer.

In further examples, the scheduling module is further configured to in response to identifying a shared subsequent timeslot after the shared available timeslot as available within the meeting organizer schedule and the availability information associated with the meeting invitee, maintain the shared available timeslot within the third layer and in response to identifying a shared subsequent timeslot after the shared available timeslot as unavailable within one or more of the meeting organizer schedule and the availability information associated with the meeting invitee, remove the shared available timeslot from the third layer.

In some examples, a method executed on a computing device to provide meeting time picker with automated suggestions is described. The method includes detecting an intent of a meeting organizer to organize a meeting, wherein the intent lists a meeting invitee, retrieving availability information associated with the meeting invitee, generating a first layer that includes a meeting organizer schedule and a second layer that includes an aggregate schedule of the meeting invitee, generating a third layer that includes a suggested schedule of a meeting time, wherein the suggested schedule includes a shared available timeslot within the meeting organizer schedule and the aggregate schedule of the meeting invitee, and presenting the first layer, the second layer, and the third layer in a scheduling grid to the meeting organizer.

In other examples, the method further includes analyzing historical meeting data associated with the meeting invitee and identifying an acceptance tendency of the meeting invitee within the historical meeting data in relation to one or more of the meeting organizer and the shared available timeslot. The method further includes detecting the acceptance tendency of the meeting Invitee to accept the meeting as failing below an acceptance threshold in relation to the one or more of the meeting organizer and the shared available timeslot and removing the shared available timeslot from the third layer. The method further includes detecting the acceptance tendency of the meeting invitee to accept the meeting as rising above an acceptance threshold in relation to the one or more of the meeting organizer and the shared available timeslot and maintaining the shared available timeslot within the third layer. The method further includes automatically scheduling the meeting at the shared available timeslot.

In some examples, a computer-readable memory device with instructions stored thereon to provide a meeting time picker with automated suggestions is described. The instructions include actions similar to actions of the method.

In other examples, the instructions further include distinguishing the first layer, the second layer, and the third layer with one or more of a coloring scheme, a highlighting scheme, and a shading scheme. The instructions further include notifying the meeting organizer of the shared available timeslot with an animation scheme for distinguishing the third layer from the first layer and the second layer.

In some examples, a means for providing a meeting time picker with automated suggestions is described. The means for providing a meeting time picker with automated suggestions includes a means for detecting an intent of a meeting organizer to organize a meeting, wherein the intent lists a meeting invitee, a means for retrieving availability information associated with the meeting invitee, a means for generating a first layer that includes a meeting organizer schedule, a second layer that includes as aggregate schedule of the meeting invitee, and a third layer that includes a suggested schedule of a meeting time, and a means for presenting the first layer, the second layer, and the third layer in a scheduling grid to the meeting organizer.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide a meeting time picker with automated suggestions, the computing device comprising:
a display component;
a memory configured to store instructions associated with a calendar application;
a processor coupled to the memory and the display component, the processor executing the calendar application in conjunction with the instructions stored in the memory, wherein the calendar application includes:
a scheduling module configured to:
detect an intent of a meeting organizer to organize a meeting, wherein the intent lists a meeting invitee;
retrieve availability information associated with the meeting invitee;
generate a first layer that includes a meeting organizer schedule, a second layer that includes an aggregate schedule of the meeting invitee, and a third layer that includes a suggested schedule of a meeting time; and
present, through the display component, the first layer, the second layer, and the third layer in a scheduling grid to the meeting organizer.

2. The computing device of claim 1, wherein the scheduling module is further configured to:
identify one or more of: a busy timeslot and an available timeslot in the meeting organizer schedule; and
insert the one or more of: the busy timeslot and the available timeslot into the first layer.

3. The computing device of claim 1, wherein the scheduling module is further configured to:
identify another meeting invitee within the intent; and
retrieve other availability information associated with the other meeting invitee.

4. The computing device of claim 3, wherein the scheduling module is further configured to:
identify a shared available timeslot within the availability information associated with the meeting invitee and the other availability information associated with the other meeting invitee; and
insert the shared available timeslot into the second layer.

5. The computing device of claim 3, wherein the scheduling module is further configured to:
identify a busy timeslot within one or more of the availability information associated with the meeting invitee and the other availability information associated with the other invitee; and
insert the busy timeslot into the second layer.

6. The computing device of claim 1, wherein the scheduling module is further configured to:
identify a shared available timeslot within the meeting organizer schedule and the availability information associated with the meeting invitee; and
insert the shared available timeslot into the third layer.

7. The computing device of claim 6, wherein the scheduling module is further configured to:
retrieve a previous location of the meeting invitee from a previous timeslot prior to the shared available timeslot;
compute a distance between the previous location and a meeting location; and
compute a travel time of the meeting invitee to the meeting location based on the distance and a travel mode associated with the meeting invitee.

8. The computing device of claim 7, wherein the scheduling module is further configured to:
identify the travel time as within an acceptable delay threshold from a start time of the meeting; and
maintain the shared available timeslot within the third layer.

9. The computing device of claim 7, wherein the scheduling module is further configured to:
identify the travel time as outside an acceptable delay threshold from a start time of the meeting; and
remove the shared available timeslot from the third layer.

10. The computing device of claim 7, wherein the scheduling module is further configured to:
detect the travel mode by analyzing a contextual information associated with the meeting invitee, wherein the contextual information is retrieved from one or more of: a contact information provider, a presence information provider, a personnel information provider, and a social networking provider associated with the meeting invitee.

11. The computing device of claim 6, wherein tire scheduling module is further configured to:
in response to identifying a shared previous timeslot before the shared available timeslot as available within the meeting organizer schedule and the availability information associated with the meeting invitee,
maintain the shared available timeslot within the third layer; and
in response to identifying a shared previous timeslot before the shared available timeslot as unavailable within one or more of the meeting organizer schedule and the availability information associated with the meeting invitee,
remove the shared available timeslot from the third layer.

12. The computing device of claim 6, wherein the scheduling module is further configured to:
in response to identifying a shared subsequent timeslot alter the shared available timeslot as available within the meeting organizer schedule and the availability information associated with the meeting invitee,
maintain the shared available timeslot within the third layer; and
in response to identifying a shared subsequent timeslot after the shared available timeslot as unavailable within one or more of the meeting organizer schedule and the availability information associated with the meeting invitee,
remove the shared available timeslot from the third layer.

13. A method executed on a computing device to provide meeting time picker with automated suggestions, the method comprising:
detecting an intent of a meeting organizer to organize a meeting, wherein the intent lists a meeting invitee;
retrieving availability information associated with the meeting invitee;
generating a first layer that includes a meeting organizer schedule and a second layer that includes an aggregate schedule of the meeting invitee;
generating a third layer that includes a suggested schedule of a meeting time, wherein the suggested schedule includes a shared available timeslot within the meeting organizer schedule and the aggregate schedule of the meeting invitee; and
presenting the first layer, the second layer, and the third layer in a scheduling grid to the meeting organizer.

14. The method of claim 13, further comprising:
analyzing historical meeting data associated with the meeting invitee; and
identifying an acceptance tendency of the meeting invitee within the historical meeting data in relation to one or more of the meeting organizer and the shared available timeslot.

15. The method of claim 14, further comprising:
detecting the acceptance tendency of the meeting invitee to accept, the meeting as falling below an acceptance threshold in relation to the one or more of the meeting organizer and the shared available timeslot; and
removing the shared available timeslot from the third layer.

16. The method of claim 14, further comprising:
detecting the acceptance tendency of the meeting invitee to accept the meeting as rising above an acceptance threshold in relation to the one or more of the meeting organizer and the shared available timeslot; and
maintaining the shared available timeslot within the third layer.

17. The method of claim 16, further comprising:
automatically scheduling the meeting at the shared available timeslot.

18. A computer-readable memory device with instructions stored thereon to provide a meeting time picker with automated suggestions, the instructions comprising:
detecting an intent of a meeting organizer to organize a meeting, wherein the intent lists a meeting invitee;
retrieving availability information associated with the meeting invitee;
generating a first layer that includes a meeting organizer schedule, and a second layer that includes an aggregate schedule of the meeting invitee; and
generating a third layer that includes a suggested schedule of a meeting time, wherein the suggested schedule includes a shared available timeslot within the meeting organizer schedule and the aggregate schedule of the meeting invitee; and
presenting the first layer, the second layer, and the third layer in a scheduling grid to the meeting organizer.

19. The computer-readable memory device of claim 18, wherein the instructions further comprise:
distinguishing the first layer, the second layer, and the third layer with one or more of a coloring scheme, a highlighting scheme, and a shading scheme.

20. The computer-readable memory device of claim 18, wherein the instructions further comprise:
notifying the meeting organizer of the shared available timeslot with an animation scheme for distinguishing the third layer from the first layer and the second layer.
